(19) United States
(12) Patent Application Publication
(10) Pub. No.: US 2026/0005782 A1
(43) Pub. Date: Jan. 1, 2026

(54) WAVELENGTH OPTIMIZATION FOR MULTI-VENDOR RECONFIGURABLE OPTICAL ADD/DROP MULTIPLEXER LINKS

(71) Applicant: AT&T Intellectual Property I, L.P., Atlanta, GA (US)

(72) Inventors: Pedro Meledina, Weehawken, NJ (US); Garrick Metivier, Union, NJ (US); Gary Armiento, Ocean, NJ (US)

(21) Appl. No.: 18/759,556

(22) Filed: Jun. 28, 2024

(51) Int. Cl. H04J 14/02

(52) U.S. Cl. CPC H04J 14/021; H04J 14/02218

(57) ABSTRACT

A method includes collecting values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors, comparing the values to previously collected values for the plurality of optical parameters, determining, based on the comparing, that a change has been detected in a power value of at least one channel of at least one of: the first reconfigurable optical add/drop multiplexer or the second reconfigurable optical add/drop multiplexer, and sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

The present disclosure relates generally to optical network operations, and relates more particularly to devices, computer-readable media, and methods for optimizing wavelength transmit power for multi-vendor reconfigurable optical add/drop multiplexer (ROADM) links in optical networks.

### BACKGROUND

Optical networks have begun shifting from single-vendor networks, in which all network equipment and links (such as reconfigurable optical add/drop multiplexers, or ROADMs) are sourced from the single vendor or manufacturer, to multi-vendor networks, in which the network equipment and links may be sourced from multiple different vendors or manufacturers. Multi-vendor networks allow the network operator to take advantage of faster development cycles, among other advantages.

### SUMMARY

Devices, computer-readable media, and methods are disclosed for optimizing wavelength transmit power for multi-vendor ROADM links in optical networks. In one example, a method performed by a processing system including at least one processor includes collecting a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors, comparing the plurality of values that is collected to previously collected values for the plurality of optical parameters, determining, based on the comparing, that a change has been detected in a power value of at least one channel of at least one of: the first reconfigurable optical add/drop multiplexer or the second reconfigurable optical add/drop multiplexer, and sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

In another example, a non-transitory computer-readable medium stores instructions which, when executed by a processing system including at least one processor, cause the processing system to perform operations. The operations include collecting a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors, comparing the plurality of values that is collected to previously collected values for the plurality of optical parameters, determining, based on the comparing, that a change has been detected in a power value of at least one channel of at least one of: the first reconfigurable optical add/drop multiplexer or the second reconfigurable optical add/drop multiplexer, and sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

In another example, a system includes a processor and a non-transitory computer-readable medium storing instructions which, when executed by the processor, cause the processor to perform operations. The operations include collecting a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors, comparing the plurality of values that is collected to previously collected values for the plurality of optical parameters, determining, based on the comparing, that a change has been detected in a power value of at least one channel of at least one of: the first reconfigurable optical add/drop multiplexer or the second reconfigurable optical add/drop multiplexer, and sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

### BRIEF DESCRIPTION OF THE DRAWINGS

The teaching of the present disclosure can be readily understood by considering the following detailed description in conjunction with the accompanying drawings, in which:

FIG. 1 illustrates an example system in which examples of the present disclosure for optimizing wavelength transmit power for multi-vendor reconfigurable optical add/drop multiplexer links in optical networks may operate;

FIG. 2 illustrates a flowchart of an example method for optimizing wavelength transmit power for multi-vendor reconfigurable optical add/drop multiplexer links in optical networks according to the present disclosure; and

FIG. 3 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses devices, computer-readable media, and methods for optimizing wavelength transmit power for multi-vendor ROADM links in optical networks. As discussed above, optical networks have begun shifting from single-vendor networks, in which all network equipment and links (such as reconfigurable optical add/drop multiplexers, or ROADMs) are sourced from the single vendor or manufacturer, to multi-vendor networks, in which the network equipment and links may be sourced from multiple different vendors or manufacturers. Multi-vendor networks allow the network operator to take advantage of faster development cycles, among other advantages.

Typically, optical optimization of equipment such as ROADMs is performed at the vendor level. For instance, for optical optimization of a ROADM, the vendor from whom the ROADM was sourced will collect optical parameters on each wavelength of the ROADM, send the collected optical parameters via an optical signal channel to a far-end shelf processor for processing, and receive on a near-end shelf processor instructions for making optical power per wavelength adjustments to the ROADM. Thus, in a multi-vendor optical network, different ROADMs may be optimized by different parties working in isolation, which makes it more difficult to optimize the network as a whole, accounting for all equipment and links.

Examples of the present disclosure optimize wavelength optical power across an optical network by compiling optical parameters collected from a plurality of ROADMs sourced from a plurality of vendors at a single external server. This single external server processes all of the optical parameters collected from the plurality of ROADMs and then sends instructions to one or more of the ROADMs to make adjustments to the optical power of one or more of their wavelengths. By using a single server to collect data from and perform optimizations of all of the ROADMs, regardless of vendor, transmission per channel in the optical network can be improved.

Examples of the present disclosure may be deployed in any type of optical network, including dense wavelength division multiplexing (DWDM) networks (such as long-haul, ultra long-haul, regional, and metro DWDM networks) and coarse wavelength division multiplexing (CWDM) networks. In this context, long-haul networks are understood to include networks designed to transmit data over distances of 1,000 to 2,500 kilometers, while regional or metro networks are understood to include networks designed to transmit data over distances of 80 to 1,000 kilometers.

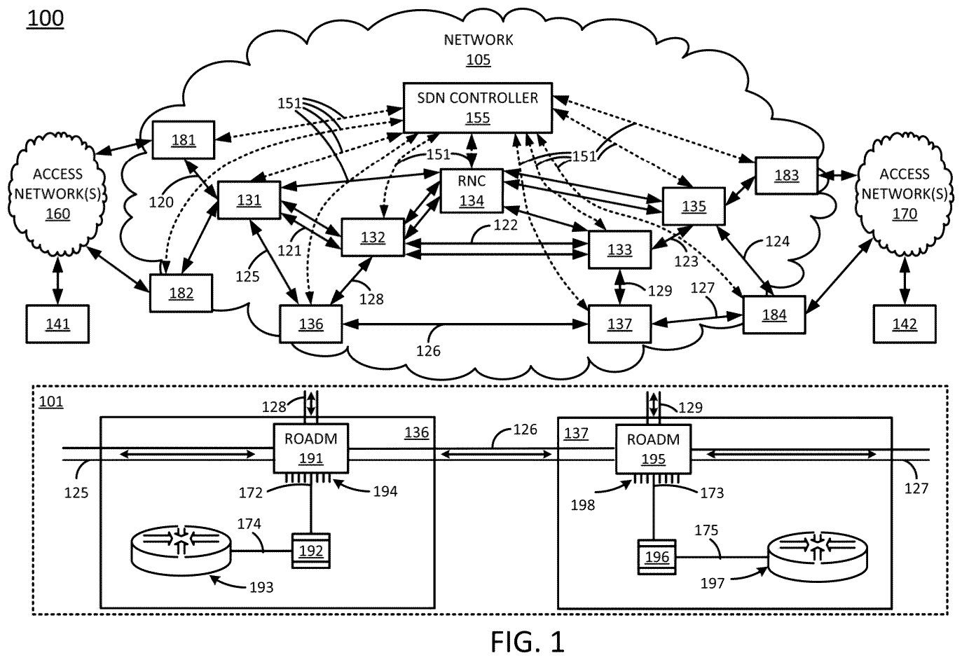

Moreover, it should be noted that the optimizations performed by the present disclosure may vary from one optical link and/or wavelength to another optical link and/or wavelength. In other words, the optimizations performed by the present disclosure may not necessarily maintain the same transmit power value (e.g., one decibel) for all wavelengths of an optical link, but may optimize in a way that maintains different transmit power values for one or more wavelengths of the optical link based on applications, conditions, and other considerations relating to the wavelengths. These and other aspects of the present disclosure are discussed in greater detail below in connection with the examples of FIGS. 1-3.

To aid in understanding the present disclosure, FIG. 1 illustrates an example system 100 in which examples of the present disclosure for optimizing wavelength transmit power for multi-vendor reconfigurable optical add/drop multiplexer links in optical networks may operate. The overall communications system 100 may include any number of interconnected networks which may use the same or different communication technologies. As illustrated in FIG. 1, system 100 may include a network 105, e.g., a core telecommunication network. In one example, the network 105 may comprise a backbone network, or transport network, such as an Internet Protocol (IP)/Multi-Protocol Label Switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may utilize IP routing (e.g., without MPLS). Furthermore, network 105 may comprise multiple networks utilizing different protocols, all utilizing a shared underlying WDM infrastructure (fibers, amplifiers, ROADMs, etc.), e.g., an optical transport network. In this regard, it should be noted that as referred to herein, “traffic” may comprise all or a portion of a transmission, e.g., a sequence or flow, comprising one or more packets, segments, datagrams, frames, cells, PDUs, service data units, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 160 and networks 170. Networks 160 and 170 may comprise wireless networks (e.g., Institute of Electrical and Electronics Engineers (IEEE) 802.11/Wi-Fi networks and the like), cellular access networks (e.g., Universal Terrestrial Radio Access Networks (UTRANs) or evolved UTRANs (eUTRANs), and the like), circuit switched networks (e.g., public switched telephone networks (PSTNs)), cable networks, digital subscriber line (DSL) networks, metropolitan area networks (MANs), Internet service provider (ISP) networks, peer networks, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may comprise separate domains, e.g., separate routing domains as compared to the network 105. In one example, networks 160 and/or networks 170 may represent the Internet in general.

In one example, network 105 may transport traffic to and from user devices 141 and 142. For instance, the traffic may relate to communications such as voice telephone calls, video and other multimedia, text messaging, emails, and so forth between the user devices 141 and 142, or between the user devices 141 and/or 142 and other devices that may be accessible via networks 160 and 170. User devices 141 and 142 may comprise, for example, cellular telephones, smart phones, personal computers, other wireless and wired computing devices, private branch exchanges, customer edge (CE) routers, media terminal adapters, cable boxes, home gateways and/or routers, and so forth.

As stated above, network 105 comprises a WDM network (e.g., DWDM or CWDM network). Accordingly, in one example, the nodes 131-137 may include optical components, such as reconfigurable add/drop multiplexers (ROADMs), and the links between nodes 131-137 may comprise fiber optic cables. Software-controlled ROADMs manage data traveling over high-capacity fiber optic lines and can automatically detect and adjust bandwidth, move traffic to different lanes, turn off wavelengths for a variety of different reasons, and so forth. Generally, each ROADM is connected to one or more other ROADMs by one or more optical fiber pairs. A given ROADM will transmit an optical signal on one fiber in a pair and receive a return signal on the other fiber in the pair; thus, each optical fiber transmits in a single direction. A Layer 1 service, or a wavelength, can then be set up between two transponders, where each transponder is connected to a nearby ROADM. The wavelength may then be routed through the ROADM network.

For ease of illustration, a portion of the links is specifically labeled as links 120-129. Inset 101 illustrates a portion of the network 105 comprising nodes 136 and 137, and links 125-129. As shown in inset 101, node 136 includes a ROADM 191 coupled to links 125, 126, and 128, a plurality of add/drop ports 194, and a router 193 coupled to the ROADM 191 via one of the plurality of add/drop ports 194 and a transponder 192 via a patch cord 172. Similarly, node 137 includes a ROADM 195 coupled to links 126, 127, and 129, a plurality of add/drop ports 198, and a network switch 197 coupled to ROADM 195 via a patch cord 173 between one of the plurality of add/drop ports 198, and a transponder 196.

In one example, one or both of the transponders 192 and 196 may comprise a muxponder that may aggregate several lower bandwidth signals from one or more network switches, routers, or other client devices at node 136 or node 137 into a combined signal for transmission over one of the network links 125, 126, 127, 128, or 129. In one example, one or both of the transponders 192 and 196 may be capable of transmitting and/or receiving optical signals for use in metro or transport applications at data rates of 100 Gb/s or greater. However, in another example, one or both of the transponders 192 and 196 may transmit and receive at lower data rates, such as 25 Gb/s, 10 Gb/s etc. ROADMs 191 and 195 may comprise colorless ROADMs, directionless ROADMs, colorless and directionless ROADMs (CD ROADMs), contentionless ROADMs, e.g., colorless, directionless, and contentionless (CDC) ROADMs, and so forth. Additionally, it should be noted that these ROADMs may include Open ROADMs with open standards allowing interoperability of different ROADMs manufactured by different vendors.

It should be noted that in each of nodes 136 and 137, any number of routers, switches, application servers, and the like may be connected to one of the plurality of add/drop ports 194 or the plurality of add/drop ports 198, e.g., via additional transponders and/or transceivers. In addition, in other examples, additional components, such as additional ROADMs, may be connected to one of the plurality of add/drop ports 194 or plurality of add/drop ports 198. For instance, in another example, node 137 may include a number of ROADMs, wavelength selective switches (WSSs), and other components that are interconnected to provide a higher degree node. In addition, as referred to herein the terms “switch” and “network switch” may refer to any of a number of similar devices, e.g., including: a Layer 2 switch (e.g., an Ethernet switch), a Layer 3 switch/multi-layer switch, a router (e.g., a router which may also include switching functions), or the like. It should also be noted that nodes 131-135 may have a same or similar setup as nodes 136 and 137. In addition, in one example, any one or more of components 181-184 may also comprise an optical node with a same or similar setup as nodes 136 and 137.

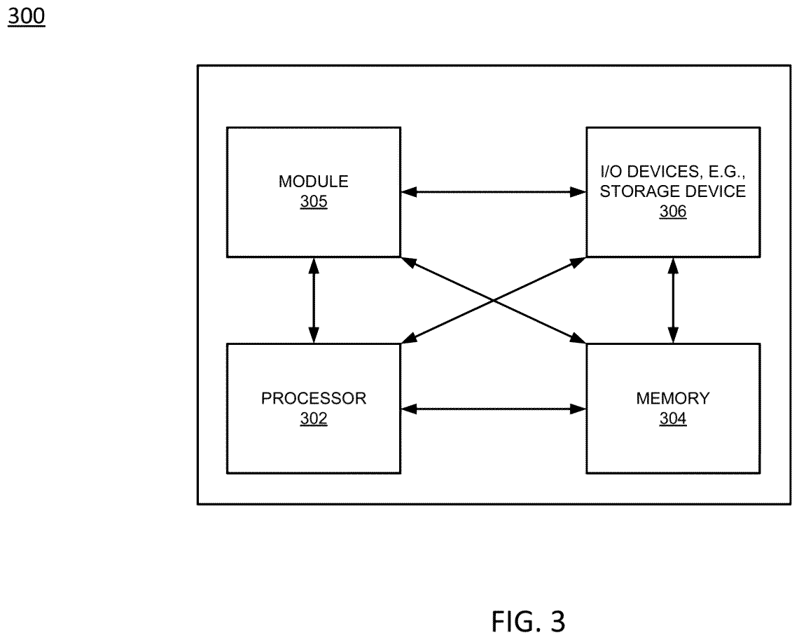

As further illustrated in FIG. 1, network 105 includes a software defined network (SDN) controller 155 and a ROADM network controller (RNC) 134. In one example, the SDN controller 155 may comprise a computing system or server, such as computing system 300 depicted in FIG. 3, and may be configured to provide one or more operations or functions for optimizing wavelength transmit power for multi-vendor reconfigurable optical add/drop multiplexer links in optical networks. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., a computing system as illustrated in FIG. 3 and discussed below) or multiple computing devices collectively configured to perform various steps, functions, and/or operations in accordance with the present disclosure. In addition, with respect to ROADMs, “configured” and “reconfigured” may refer to instructions to adjust a WSS to route different wavelengths to different fibers/links and/or to different add/drop ports. With respect to network switches and transponders, “configured” and “reconfigured” may refer to instructions to send or receive at a particular bitrate, to utilize a particular transmit power, to transmit or receive on a particular wavelength, and the like.

In one example, nodes 131-137 and components 181-184 (and/or the devices therein) may be controlled and managed by SDN controller 155. For instance, in one example, SDN controller 155 is responsible for such functions as provisioning and releasing instantiations of virtual network functions (VNFs) to perform the functions of routers, switches, and other devices, provisioning routing tables and other operating parameters for the VNFs, and so forth. Thus, various components of network 105 may comprise virtual network functions which may physically comprise hardware executing computer-readable/computer-executable instructions, code, and/or programs to perform various functions. For example, the functions of SDN controller 155 may include the selection of a network function virtualization infrastructure (NFVI) from among various NFVIs available at nodes 131-137 in network 105 to host various devices, such as routers, gateways, switches, route reflectors, firewalls, media servers, and so forth. To illustrate, network switches 193 and 197 may physically reside on host devices that may be configured to be a firewall, a media server, a network switch, a router, and so forth.

In addition, SDN controller 155 may also manage the operations of optical components of the network 105. For instance, SDN controller 155 may configure paths for wavelength connections via the network 105 by configuring and reconfiguring ROADMs at nodes 131-137 and components 181-184. For example, SDN controller 155 may provide instructions to control WSSs within the ROADMs, as well as transceivers and/or transponders connected to the ROADM add/drop ports. In one example, SDN controller 155 may maintain communications with nodes 131-137 and components 181-184 (and/or the devices therein) via a number of control links 151 which may comprise secure tunnels for signaling communications over an underling IP infrastructure of network 105, e.g., including fibers/links 120-129, etc. In other words, the control links 151 may comprise virtual links multiplexed with transmission traffic and other data traversing network 105 and carried over a shared set of physical links. Alternatively, or in addition, the control links 151 may comprise out-of-band links, e.g., optical or non-optical connections that are different from fibers/links 120-129.

In one example, SDN controller 155 may be in communication with the RNC 134. For example, RNC 134 may be responsible for instantiating and releasing instances of virtual machines at nodes 131-137 and for configuring and reconfiguring operations of associated ROADMs, such as ROADMs 191 and 195, transponders 192 and 196, and other devices at the nodes 131-137 such as transceivers, network switches, and so on. Alternatively, the RNC may control respective node controllers at the nodes 131-137 to instantiate and release instances of virtual machines and to configure and reconfigure devices at the nodes 131-137. Thus, in one example, RNC 134 may receive instructions for configuring and reconfiguring ROADMs 191 and 195 from SDN controller 155, e.g., via control links 151. Alternatively, or in addition, control links 151 may provide connections between SDN controller 155 and ROADMs 191 and 195, transponders 192 and 196, and other devices at the nodes such as transceivers and network switches without the involvement of the RNC 134 and/or individual node controllers. In one example, the SDN controller 155 may also comprise a virtual machine operating on one or more NFVI/host devices, or may comprise one or more dedicated devices. For instance, SDN controller 155 may be collocated with one or more VNFs, may be deployed in one or more different host devices, or at a different physical location or locations, and so forth.

In addition, in one example, SDN controller 155 may represent a processing system comprising a plurality of controllers, e.g., a multi-layer SDN controller, one or more federated Layer 0/physical layer SDN controllers, and so forth. For instance, a multi-layer SDN controller may be responsible for instantiating, tearing down, configuring, reconfiguring, and/or managing Layer 2 and/or Layer 3 VNFs (e.g., a network switch, a Layer 3 switch and/or a router, etc.), whereas one or more Layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, for instructing optical devices at various nodes to provision optical network paths in accordance with the present disclosure, and so forth. In one example, the Layer 0 SDN controller(s) may in turn be controlled by the multi-layer SDN controller. For instance, each Layer 0 SDN controller may be assigned to nodes/optical components within a portion of the network 105. In addition, these various components may be co-located or distributed among a plurality of different dedicated computing devices or shared computing devices (e.g., NFVI) as described herein.

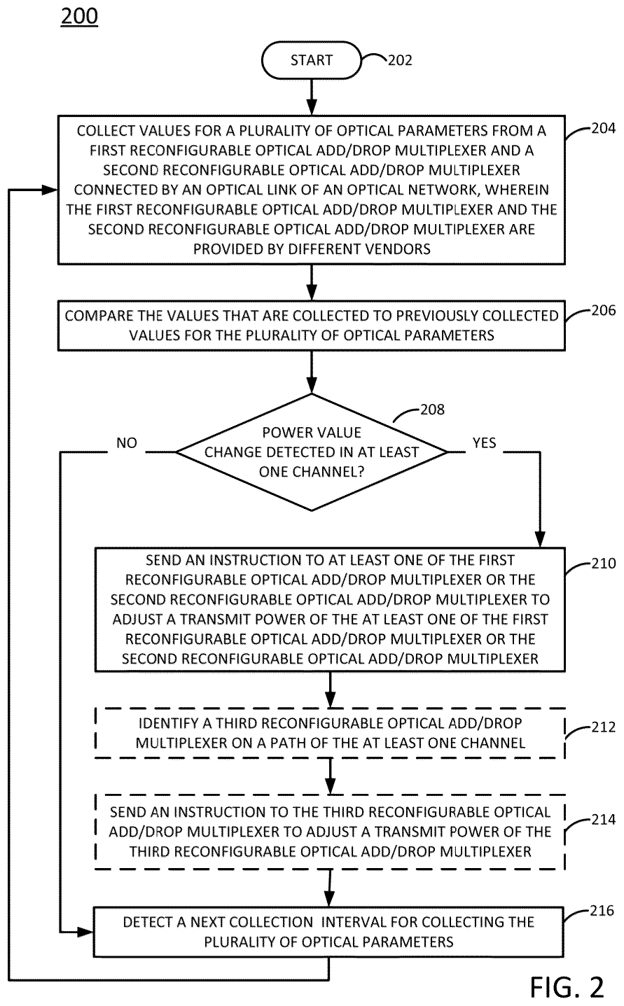

In one example, the SDN controller 155 may be configured to perform operations in connection with examples of the present disclosure for optimizing wavelength transmit power for multi-vendor reconfigurable optical add/drop multiplexer links in optical networks. For instance, in one example, the SDN controller 155 may collect a plurality of values for optical parameters from the nodes 131-137 and may, based on a comparison of the collected values to previously collected or observed values for the optical parameters, determine adjustments to be made to power values (e.g., a transmit power) of wavelengths carried by one or more nodes 131-137 and/or one or more links 120-129, as discussed in further detail with respect to FIG. 2.

It should be noted that the system 100 has been simplified. In other words, the system 100 may be implemented in a different form than that illustrated in FIG. 1. For example, the system 100 may be expanded to include additional networks and additional network elements (not shown) such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions and/or combine elements that are illustrated as separate devices. For example, SDN controller 155, RNC 134, and/or other network elements may comprise functions that are spread across several devices that operate collectively as a SDN controller, an RNC, etc. In another example, RNC 134 and SDN controller 155 may be integrated into a single device. In another example, RNC 134 may maintain its own connections to nodes 131-137 and components 181-184 and may send instructions to various devices to dynamically scale the capacity of the network 105 in accordance with the present disclosure. In another example, nodes 131-137 and/or components 181-184 may include fiber loss test sets (FLTSs), optical time domain reflectometers (OTDRs), polarization mode dispersion (PMD) measurement devices, and the like which may be used to measure fiber loss and PMD over various links.

In addition, the foregoing includes examples where operations for optimizing wavelength transmit power for multi-vendor reconfigurable optical add/drop multiplexer links in optical networks may be performed by RNC 134, and/or by RNC 134 in conjunction with other devices under the control and instruction of SDN controller 155. However, in other, further, and different examples, aspects of optimizing wavelength transmit power may include transponders and/or network switches performing one or more operations autonomously. Thus, these and other modifications of the system 100 are all contemplated within the scope of the present disclosure.

FIG. 2 illustrates a flowchart of an example method 200 for optimizing wavelength transmit power for multi-vendor reconfigurable optical add/drop multiplexer links in optical networks according to the present disclosure. In one example, steps, functions and/or operations of the method 200 may be performed by a network-based device, such as SDN controller 155 in FIG. 1, or any one or more components thereof, such as a processing system. Alternatively, or in addition, the steps, functions and/or operations of the method 200 may be performed by a processing system collectively comprising a plurality of devices as illustrated in FIG. 1, such as SDN controller 155, RNC 134, ROADM 191 and/or ROADM 195, and/or transponders 192 and 196, and so forth. In one example, the steps, functions, or operations of method 200 may be performed by a computing device or system 300, and/or a processing system 302 as described in connection with FIG. 3 below. For illustrative purposes, the method 200 is described in greater detail below in connection with an example performed by a processing system.

The method 200 begins in step 202. In step 204, the processing system may collect values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors.

In one example, the first ROADM may be provided (e.g., manufactured or sold) by a first vendor, while the second ROADM may be provided by a second vendor, different from the first vendor. Thus, the vendor who provides the first ROADM may not have access to the values of the optical parameters of the second ROADM, and the vendor who provides the second ROADM may not have access to the values of the optical parameters of the first ROADM. The optical link connecting the first ROADM and the second ROADM may comprise an optical fiber that carries a plurality of wavelengths of light. One of the first ROADM and the second ROADM may be the transmitting ROADM on the optical link, while the other of the first ROADM and the second ROADM may be the receiving ROADM on the optical link.

As discussed above, in one example, the processing system may be part of an SDN controller or another computing device that is separate from the first ROADM and the second ROADM. In one example, the processing system is part of a computing device that is independent of the different vendors who provide the first ROADM and the second ROADM. For instance, the processing system may be operated by an operator of the optical network, who is not a provider of either of the first ROADM or the second ROADM.

In one example, the processing system may collect the values for the plurality of optical parameters by sending a prompt to the first ROADM and the second ROADM, where the prompt causes the first ROADM and the second ROADM to send the values to the processing system. In one example, the processing system may send prompts to collect the values on a periodic basis, on-demand (e.g., as requested by an operator of the optical network), in response to the detection of a predefined event (e.g., a key performance indicator of the optical network falling below a threshold value), or the like. In another example, the first ROADM and the second ROADM may be programmed to periodically send the values to the processing system. In either case, the plurality of values can be collected from the first ROADM and the second ROADM simultaneously.

In one example, the plurality of optical parameters may include at least one of: an optical peak (output) power per channel (wavelength of light) of the optical link, a drift per channel of the optical link, a bit error rate (BER) per transponder of the ROADM, and/or other optical parameters.

In one example, optical peak power per channel may be collected from WSS ports of the first ROADM and the second ROADM. For instance, an optical power monitor (OPM) of the first ROADM or the second ROADM may perform a scan of the WSS port.

In one example, the drift per channel may be calculated, for each channel, as the optical peak of the channel minus the target optical power of the channel.

In one example, the BER per transponder may represent a baseline value that is determined prior to wavelength power optimization in subsequent steps of the method 200. The BER per transponder may thus serve as a threshold maximum BER that should not be exceeded once wavelength power optimization is completed.

In step 206, the processing system may compare the values that are collected to previously collected values for the plurality of optical parameters.

As discussed above, the values for the plurality of optical parameters may be collected periodically, according to a collection interval. This allows the values (or other metrics derived from the values) to be tracked over time so that changes in power values may be detected, as discussed in further detail below.

In step 208, the processing system may determine, based on the comparing, whether a change has been detected in a power value of at least one channel of at least one of: the first reconfigurable optical add/drop multiplexer or the second reconfigurable optical add/drop multiplexer.

In one example, the power value may be at least one of: a drift of the transmitting ROADM, a pre-forward error correction (FEC) BER of the receiving ROADM, or the optical power received by the receiving ROADM. As discussed above, one of: the first ROADM and the second ROADM may be the transmitting ROADM, while the other of: the first ROADM and the second ROADM may be the receiving ROADM.

In one example, a power value change may be detected in multiple channels (i.e., more than just one channel) in step 208. For instance, power value changes may be detected in both the transmitting ROADM and the receiving ROADM.

If the processing system concludes in step 208 that a change in a power value has been detected, then the method 200 may proceed to step 210. In step 210, the processing system may send an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

For instance, depending on which ROADM of the first ROADM and the second ROADM is transmitting over the at least one channel, the processing system may instruct the transmitting ROADM to adjust its transmit power over the at least one channel (e.g., by either increasing or decreasing the transmit power by a specified amount).

In one example, the magnitude of the adjustment to the transmit power may be based on the span loss of the optical link connecting the first ROADM and the second ROADM or on the optical signal to noise ratio (OSNR) that the operator of the optical network wants to maintain. The magnitude of the adjustment may also depend on the type of application(s) supported by the first ROADM and the second ROADM, the type of the fiber of the optical link, or other hardware used in the optical network. In some examples, machine learning techniques may be used to learn, through multiple iterations of the method 200, the appropriate magnitudes of adjustments needed to achieve desired results.

In optional step 212 (illustrated in phantom), the processing system may identify a third reconfigurable optical add/drop multiplexer on a path of the at least one wavelength. In one example, the processing system may identify every ROADM on the path of the at least one channel. For instance, the processing system may be provided with or may perform a routine to discover a topology of the optical network, so that the processing systems knows which ROAMDs in the optical network are connected by which links. Thus, the processing system may identify at least one ROADM (e.g., the third ROADM) in step 212, but the processing system may identify additional ROADMs as well (so that more than one ROADM on the path of the at least one channel is identified).

In step 214 (illustrated in phantom), the processing system may send an instruction to the third reconfigurable optical add/drop multiplexer to adjust a transmit power of the third reconfigurable optical add/drop multiplexer. As discussed above, the processing system may identify more than one ROADM on the path of the at least one channel in step 212. In this case, the processing system may instruct every ROADM identified in step 212 to adjust its transmit power. However, every ROADM may not necessarily be instructed to make the same adjustment to its transmit power; the exact magnitude and nature (e.g., increase or decrease) of the adjustment may vary depending on the ROADM.

In one example, as discussed above, any adjustment made to the transmit power of any ROADM may be calculated so that a baseline BER per channel is not exceeded for any transponder.

In step 216, the processing system may detect a next collection interval for collecting the values of the plurality of optical parameters. In one example, all optical parameters of the plurality of optical parameters may be collected according to the same collection interval. For instance, all optical parameters of the plurality of optical parameters may be collected every x minutes. In another example, however, different optical parameters of the plurality of optical parameters may be collected according to different collection intervals. For instance, optical peak power per channel may be collected every x minutes, drift per channel may be collected every y minutes, and BER may be collected every z minutes, where x≠y≠z. Thus, at least two of the optical parameters may be collected with different frequencies.

Referring back to step 208, if the processing system concludes in step 208 that a change in a power value has not been detected, then the method 200 may proceed directly to step 216 and proceed as described above (i.e., bypassing steps 210-214).

In one example, the method 200 may be performed for each pair of ROADMs in the optical network that is connected by an optical link.

It should be noted that the method 200 may be expanded to include additional steps or may be modified to include additional operations with respect to the steps outlined above. For instance, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for optimizing wavelength transmit power for multi-vendor reconfigurable optical add/drop multiplexer links in optical networks, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, transceivers, power units, and so forth. Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200, or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the methods discussed above can be used to configure a hardware processor to perform the steps, functions and/or operations of the above disclosed method 200. In one example, instructions and data for the present module or process 305 for optimizing wavelength transmit power for multi-vendor reconfigurable optical add/drop multiplexer links in optical networks (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for optimizing wavelength transmit power for multi-vendor reconfigurable optical add/drop multiplexer links in optical networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
collecting, by a processing system including at least one processor, a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors;
comparing, by the processing system, the plurality of values that is collected to previously collected values for the plurality of optical parameters;
determining, by the processing system based on the comparing, that a change has been detected in a power value of at least one channel of at least one of: the first reconfigurable optical add/drop multiplexer or the second reconfigurable optical add/drop multiplexer; and
sending, by the processing system, an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

2. The method of claim 1, wherein the processing system is part of a computing device that is separate from the first reconfigurable optical add/drop multiplexer and the second reconfigurable optical add/drop multiplexer.

3. The method of claim 2, wherein the computing device is a software defined networking controller.

4. The method of claim 1, wherein the collecting comprises sending a prompt to the first reconfigurable optical add/drop multiplexer and the second reconfigurable optical add/drop multiplexer, where the prompt causes the first reconfigurable optical add/drop multiplexer and the second reconfigurable optical add/drop multiplexer to send the plurality of values to the processing system.

5. The method of claim 1, wherein the plurality of values is collected from the first reconfigurable optical add/drop multiplexer and the second reconfigurable optical add/drop multiplexer simultaneously.

6. The method of claim 1, wherein the plurality of optical parameters includes at least one of: an optical peak power per channel of the optical link, a drift per channel of the optical link, a bit error rate per transponder of the first reconfigurable optical add/drop multiplexer, or a bit error rate per transponder of the second reconfigurable optical add/drop multiplexer.

7. The method of claim 6, wherein the optical peak power per channel is collected from a wavelength selective switch of at least one of: the first reconfigurable optical add/drop multiplexer or the second reconfigurable optical add/drop multiplexer.

8. The method of claim 6, wherein the drift per channel is calculated, for each channel of the optical link, as the optical peak power per channel of the each channel minus a target optical power of the each channel.

9. The method of claim 6, wherein the bit error rate per transponder serves as a threshold maximum bit error rate that should not be exceeded by an adjustment to adjust a transmit power of the at least one of: the first reconfigurable optical add/drop multiplexer or the second reconfigurable optical add/drop multiplexer according to the instruction.

10. The method of claim 6, wherein at least two of the plurality of optical parameters are collected with different frequencies.

11. The method of claim 1, wherein the power value is at least one of: a drift of a transmitting reconfigurable optical add/drop multiplexer of the first reconfigurable optical add/drop multiplexer and the second reconfigurable optical add/drop multiplexer, a pre-forward error correction bit error rate of a receiving reconfigurable optical add/drop multiplexer of the first reconfigurable optical add/drop multiplexer and the second reconfigurable optical add/drop multiplexer, or an optical power received by the receiving reconfigurable optical add/drop multiplexer.

12. The method of claim 1, further comprising:
identifying, by the processing system, a third reconfigurable optical add/drop multiplexer on a path of at least one wavelength; and
sending, by the processing system, an instruction to the third reconfigurable optical add/drop multiplexer to adjust a transmit power of the third reconfigurable optical add/drop multiplexer.

13. The method of claim 1, further comprising:
detecting, by the processing system, a next collection interval for collecting the plurality of values of the plurality of optical parameters; and
repeating, by the processing system, the collecting, the comparing, the determining, and the sending.

14. The method of claim 1, wherein the processing system is separate from the first reconfigurable optical add/drop multiplexer and the second reconfigurable optical add/drop multiplexer.

15. The method of claim 1, wherein the optical network is a multi-vendor dense wavelength division multiplexing network.

16. The method of claim 15, wherein the multi-vendor dense wavelength division multiplexing network is at least one of: an ultra long-haul dense wavelength division multiplexing network, a long-haul dense wavelength division multiplexing network, a regional dense wavelength division multiplexing network, or a metro dense wavelength division multiplexing network.

17. The method of claim 1, wherein the optical network is a multi-vendor coarse wavelength division multiplexing network.

18. The method of claim 1, wherein the processing system is operated by an operator of the optical network who is separate from the different vendors.

19. A non-transitory computer-readable medium storing instructions which, when executed by a processing system including at least one processor, cause the processing system to perform operations, the operations comprising:
collecting a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors;
comparing the plurality of values that is collected to previously collected values for the plurality of optical parameters;
determining, based on the comparing, that a change has been detected in a power value of at least one channel of at least one of: the first reconfigurable optical add/drop multiplexer or the second reconfigurable optical add/drop multiplexer; and
sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.

20. A system comprising:
a processor; and
a non-transitory computer-readable medium storing instructions which, when executed by the processor, cause the processor to perform operations, the operations comprising:
collecting a plurality of values for a plurality of optical parameters from a first reconfigurable optical add/drop multiplexer and a second reconfigurable optical add/drop multiplexer connected by an optical link of an optical network, wherein the first reconfigurable optical add/drop multiplexer and the second reconfigurable optical add/drop multiplexer are provided by different vendors;
comparing the plurality of values that is collected to previously collected values for the plurality of optical parameters;
determining, based on the comparing, that a change has been detected in a power value of at least one channel of at least one of: the first reconfigurable optical add/drop multiplexer or the second reconfigurable optical add/drop multiplexer; and
sending an instruction to at least one of: the first reconfigurable optical add/drop multiplexer or the second reconfigurable optical add/drop multiplexer to adjust a transmit power of the at least one of: the first reconfigurable optical add/drop multiplexer or the second reconfigurable optical add/drop multiplexer.
